(19) United States
(12) Patent Application Publication
(10) Pub. No.: US 2012/0129037 A1
(43) Pub. Date: May 24, 2012

(54) ELECTROCHEMICAL ENERGY STORAGE CELL

(75) Inventors: Claus-Rupert Hohenthanner, Hanau (DE); Tim Schaefer, Niedersachswerfen (DE); Joerg Kaiser, Kamenz (DE)

(73) Assignee: LI-TEC BATTERY GMBH, Kamenz (DE)

(21) Appl. No.: 13/146,039

(22) PCT Filed: Jan. 26, 2010
(86) PCT No.: PCT/EP10/00448

§ 371 Date: Feb. 7, 2012

(30) Foreign Application Priority Data
Jan. 26, 2009 (DE) 10 2009 006 117.7

(51) Int. Cl. H01M 2/06; H01M 2/30; H01M 10/02

(52) U.S. Cl. 429/153; 429/179

(57) ABSTRACT

The electric energy storage cell according to the invention is provided with: an active part, which is designed and adapted to store electric energy supplied externally and to release stored electric energy to the exterior; a casing consisting of a film material, which surrounds the active part in a gas- and liquid-tight manner; and at least two current collectors that are connected to the active part and are designed and adapted to supply electric current externally to the active part and to release electric current from the active part to the exterior. According to the invention, the part that is surrounded by the casing follows the contours of a prismatic structure with a substantially parallelepipedal form, said structure extending to a substantially lesser extent in a first spatial direction than in the other two remaining spatial directions and substantially defining two opposing, parallel flat faces and four narrow faces that connect the two flat faces. The first and the second current collectors project from the casing parallel to the planes of the two flat faces in opposite directions from two opposing narrow faces. The extension of said first and second current collector along the narrow faces from which they project is greater than half the length of said narrow faces.

The present invention relates to an electrochemical energy storage cell according to the preamble of Claim 1.

Batteries (primary storage units) and accumulators (secondary storage units) for storing electric energy are known, which are composed of one or more storage cells in which on the application of a charging current, in an electrochemical charging reaction between a cathode and an anode in or between an electrolyte, electrical energy is converted into chemical energy and therefore stored, and in which on the application of an electrical load chemical energy is converted into electrical energy in an electrochemical discharge reaction. Primary storage units are generally only charged up once and are to be disposed of after discharging, while secondary storage units allow multiple (from several 100 to more than 10000) cycles of charging and discharging. It is to be noted in this context that accumulators are sometimes referred to as batteries, for example vehicle batteries, which as is well known are subject to frequent charging cycles.

In recent years primary and secondary storage units based on lithium compounds have been increasing in importance. These have a high energy density and thermal stability, supply a constant voltage for a small self-discharge and are free from the so-called memory effect.

It is known to produce energy storage units and in particular lithium batteries and accumulators in the form of thin sheets. The paper “Primary and rechargeable lithium batteries” submitted to the Inorganic-chemical technology workshop at TU Graz by Dr. K.-C. Möller and Dr. M. Winter in February 2005 shows e.g. lithium-ion polymer cells in the format of a cheque card or even a smart-card. To refer to the functional principle of a lithium-ion cell this paper is used as an example. In such cells cathode and anode material, electrodes and separators in the form of thin films are placed on top of one another in a suitable manner (stacked) and packed in a casing film made of a composite material, wherein current collectors project to the side from an edge of the cell. In particular, a current collector film made of expanded metal (copper) is first placed between two anode films made of graphite and laminated, and in the same manner two current collector films made of expanded metal (Aluminium) are each placed between two cathode films made of LiCoO2 and laminated. The cathode films have half the capacitance of an anode film. The film triplet of the anode is then laminated in between two separator films, and subsequently the two film triplets of the half-cathodes are laminated onto this package. Such a cell is then extracted and dried, soaked with electrolyte made of 1 M LiCIO4 in 1:1 ethylene carbonate:dimethyl carbonate and welded into aluminium composite film, specifically such that elongated sections of the current collecting films pass through the weld seam on one side and project to the exterior as connections or current collectors.

A similar structure is also described in EP 1 475 852 A1. Here two film triplets are provided on the anode side and three film triplets on the cathode side, each arranged alternately and separated from one another by separator films. By changing the number of anode and cathode pairs the capacitance of such a cell can be set as required. In addition, the structure of the current collectors fed to the exterior differs from that shown in the paper cited above. Specifically, here it is not the case that extensions of the current collector films are collected together and jointly fed through a weld seam of the film to the exterior, but rather the ends of the current collector films are collected together inside the casing film and connected using connection means such as rivets, which extend perpendicularly through the casing film, to a rod-shaped current collector placed on top of the casing film. Inside the casing film between this and the ends of the respective electrode placed on top of one another, a metal piece is provided as a counter-support, which is riveted together. In addition, an insulator material is arranged and riveted together internally and externally between the casing film and the current collector or the metal piece. The externally placed current collectors then in turn project from an edge of the planar cell.

In EP 1 562 242 A2 a rod-shaped current collector separate from the ends of the current collector films is also provided, but which is already connected to the ends of the current collector films inside the casing film and is again fed through the weld seam of the casing film to the exterior. The rod-shaped current collectors thus project either from one edge or from opposite edges of the flat cell. The document is less concerned with the construction of the current collectors than with the prevention of folds forming in the separator films, however.

Contacting of a flat cell at opposite edges of the cell, as is indicated in EP 1 562 242 A2—without specifying any clear technical reason or technical implementation, is rather untypical. In EDP applications, miniature batteries in card format are typically plugged into spring connectors or male multipoint connectors, in which contacts are positioned in a row. If on the other hand multiple flat cells are stacked to form a cell package, as are found for example in car batteries due to the higher voltages and capacitances required there, then the individual parts are also wired together on one side, as is shown for example in WO 2008/128764 A1, WO 2008/128769 A1, WO 2008/128770 A1, WO 2008/128771 A1 or JP 07-282841 A.

The contacting of a flat cell at opposite edges can be advantageous when it is associated with a holding function. If the current collectors are then rod-shaped however, as in EP 1 562 242 A2, the positional stability about the axis defined by the rod-shaped current collectors is not defined and the stability of the current collectors, i.e., the possible retaining force, is small. Even if one of the more strip-like current collectors, shown in the other documents cited above, were to project from the opposite edge, this would still not result in the desired positional stability.

It is an object of the present invention therefore to create a flat electrochemical cell, which can be held in a stable position at opposite edges of the cell while simultaneously providing a current collection function.

The object is achieved by the features of Claim 1. Advantageous extensions of the invention form the subject matter of the dependent claims.

An electric energy storage cell according to the invention is equipped with an active part, which is designed and adapted to store electric energy supplied externally and to release stored electric energy to the exterior; a casing consisting of a film material, which surrounds the active part in a gas- and liquid-tight manner; and at least two current collectors that are connected to the active part and are designed and adapted to supply electric current externally to the active part and to release electric current released by the active part to the exterior. According to the invention, the part that is surrounded by the casing follows the contours of a prismatic structure of substantially ashlar-formed form, said structure extending to a substantially lesser extent in a first spatial direction than in the other two remaining spatial directions, and thus defining two opposing, substantially parallel flat faces and four narrow faces that connect the two flat faces. The first and the second current collectors project from the casing parallel to the planes of the two flat faces in opposite directions from two opposing narrow faces. The extension of said first and second current collector along the narrow faces from which they project is greater than half the length of said narrow faces. In particular the extension of the first and the second current collector along the narrow faces from which they project is at least two thirds, preferably at least three quarters of the length of said narrow faces.

Having opposing current collectors of sufficient length according to the invention, contacting of a flat cell at opposite edges also facilitates a satisfactory holding function. The possible retaining force is sufficient to keep the cell in its position in a stable manner and to hold it in place.

An eccentric arrangement of the first and the second current collector in relation to the respective narrow faces can be advantageous for example if the cell is suspended. In that case, gravity is enough to ensure a fundamental positional definition, while angular deviations can be compensated for along the extension of the current collectors. By contrast a central arrangement is to be preferred if the cell is mainly disposed in a lying position.

The most stable support, and therefore the smallest forces and moments applied to the cell, are obtained when the first and the second current collector extend substantially over the entire length of the narrow faces from which they project.

The casing preferably consists of a laminated film which surrounds the laminate formed from electrodes and separation layers in a gas- and liquid-tight manner. In particular, the casing can consist of a first insulating layer, a conductor layer and a second insulating layer, wherein the insulating layers are preferably formed from a plastic and the conductor layer preferably from aluminium or an aluminium alloy or another metal or another metal alloy. In this manner, different functions and properties of the casing can be satisfied, such as weldability, mechanical strength, electric and magnetic screening, tightness against liquids, vapours and gases, in particular water, water vapour and air from the outside and resistance to acids and electrolytes from the inside.

The casing in particular is constructed such that it has at least one weld seam, preferably two weld seams extending along opposing narrow faces, particularly preferably also having a weld seam extending beyond one of the two flat faces or along a third narrow face, or such that it has two partial films which are welded together along the narrow faces.

One embodiment is constructed such that at least one of the current collectors has an inner part, located inside the casing, and an outer part, located outside the casing, wherein the inner part of the current collector is connected to the active part of the storage cell. In particular, the at least one current collector can be passed through a weld seam of the casing.

This structure realises a particularly smooth and flat contour of the cell.

Alternatively at least one of the current collectors can rest on the outside of the casing and be contacted to the active part through the casing. This structure is highly robust.

The cell can be constructed such that at least one of the current collectors has at least one through hole in the projecting region. Also, at least one of the current collectors in the projecting region can also have a plurality of through holes, wherein preferably at least one of the through holes has a different diameter than other through holes. In addition, one of the current collectors in the projecting region can have at least one through hole at a point in the width direction at which the other current collector has no through hole in the projecting region. These arrangements allow both a centring and additional fixing against slippage parallel to the surfaces of the current collectors, and a coding of the polarity, in order to exclude a reverse-polarity installation.

The invention is suitable for all types of electric energy storage cells in which the storage and release of the electric energy take place by respective electrochemical reactions. A particularly flat design of the active part, which substantially determines the thickness of the cell, is obtained by a laminated structure with films of chemically active materials, electrically conducting materials and isolation materials in a suitable layered arrangement. Thus the active part can comprise a plurality of electrodes of two types, wherein in each case an electrode of a first type is isolated by an isolation layer from the electrode of a second type, wherein the electrodes of the first type and the electrodes of the second type are each connected to each other and to one of the current collectors.

The invention is particularly suited to galvanic cells, in particular secondary cells, based on lithium ions.

Advantageously the cell is evacuated, so that the active part can be kept free of air flow and moisture.

The above and other features, objects and advantages of the present invention are will become clearer from the following description, which has been prepared with reference to the enclosed drawings.

They show:

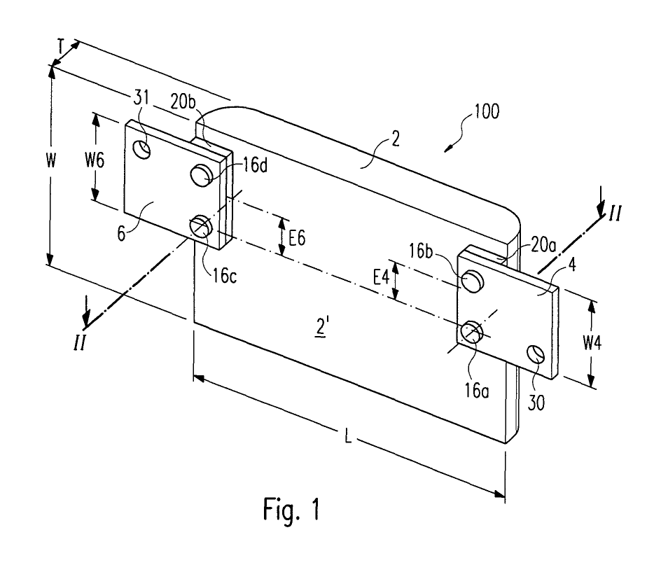

FIG. 1 a perspective view of a storage cell of a first preferred embodiment of the present invention;

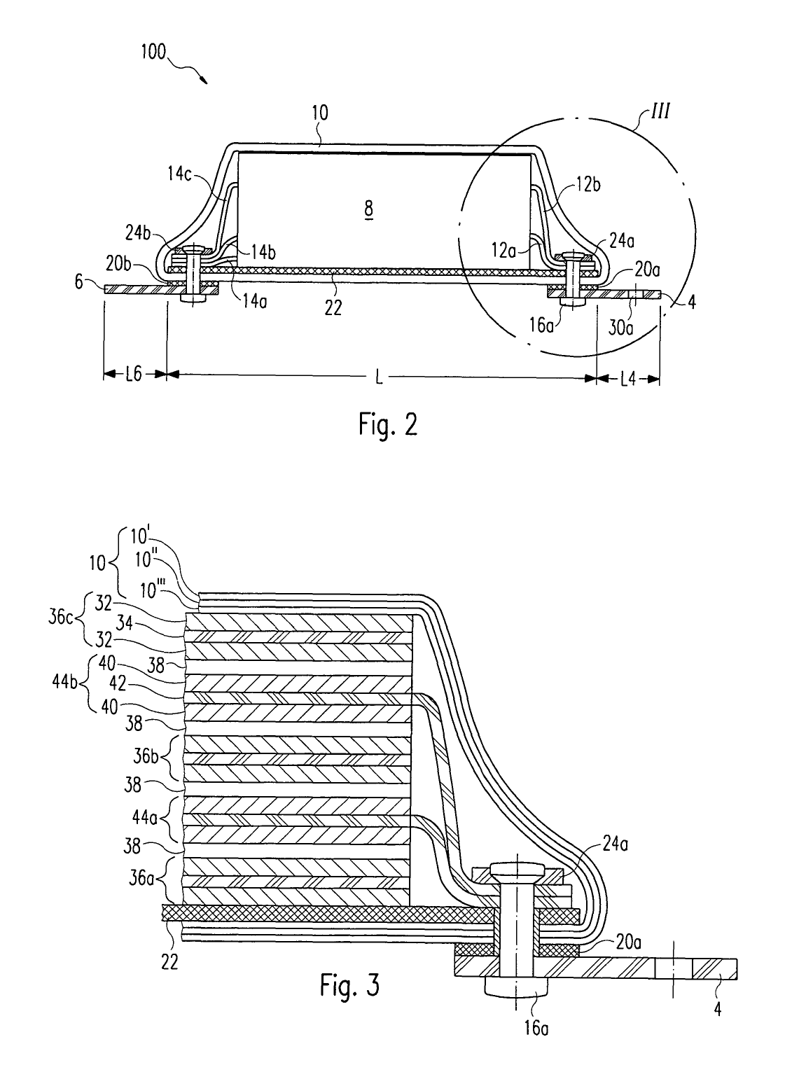

FIG. 2 a sectional view of the storage cell shown in

FIG. 1 along a plane II in FIG. 1;

FIG. 3 an enlarged view of a detail of the storage cell shown in FIGS. 1 and 2 along a line III in FIG. 2;

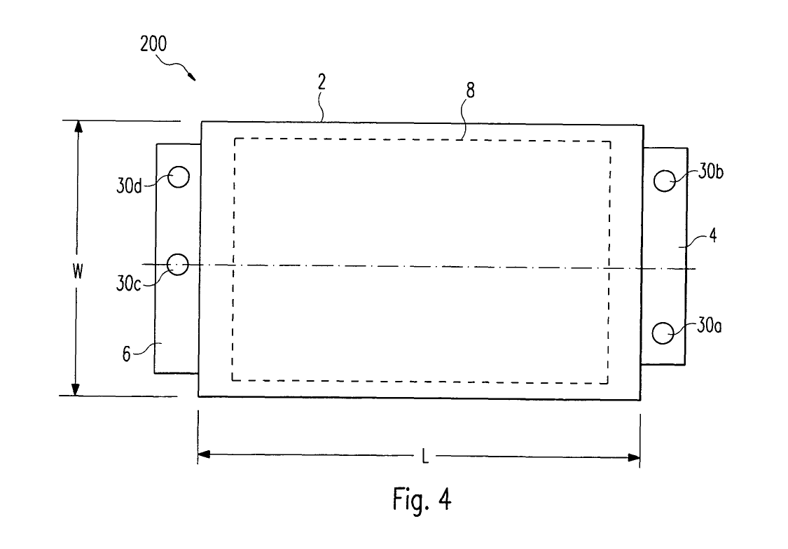

FIG. 4 a plan view of a storage cell of a second preferred embodiment of the present invention;

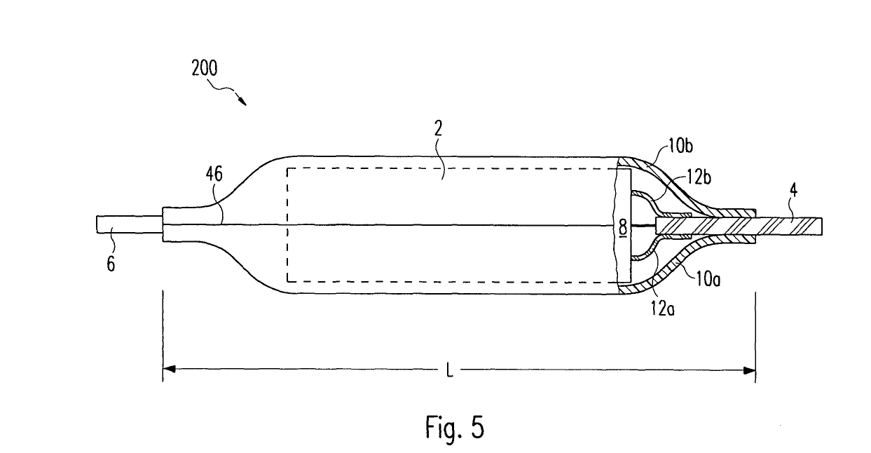

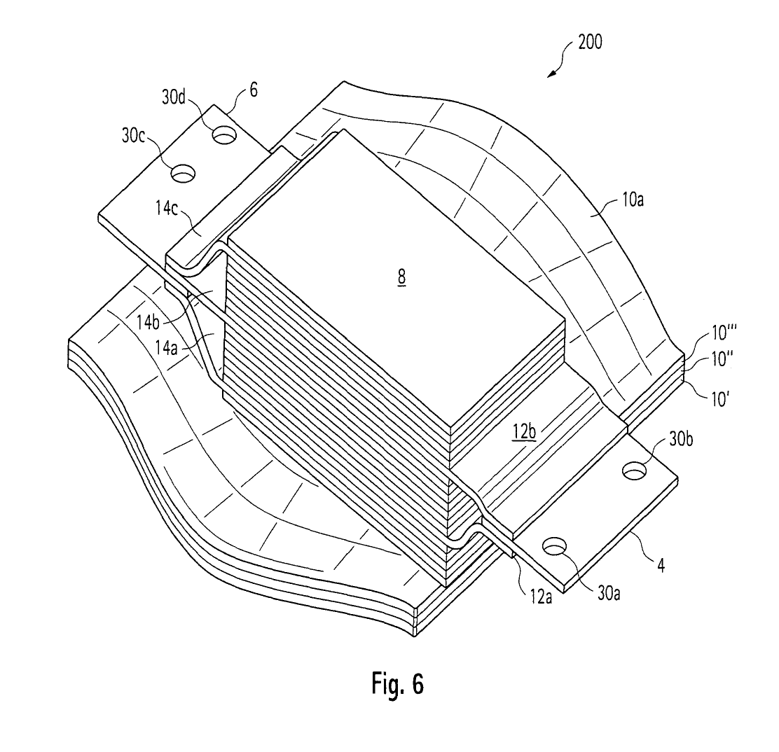

FIG. 5 a side view of the storage cell shown in FIG. 4, which is partially cut along a plane V in FIG. 4;

FIG. 6 a view of an unfinished assembly state of the storage cell shown in FIGS. 4 and 5.

It is pointed out that the representations in the Figures are schematic and restricted to the reproduction of the features most important for understanding the invention. It is also noted that the dimensions and proportions reproduced in the Figures and are solely chosen for clarity of illustration and to be understood as in no way limiting or mandatory. in particular the size in relation to the other spatial directions in some drawings is shown considerably exaggerated.

In FIGS. 1 to 3 a lithium-ion accumulator cell 100 is represented as a first preferred embodiment of an electric energy storage cell according to the invention. Of these, FIG. 1 is a perspective overall view of the accumulator cell 100, FIG. 2 is a longitudinal sectional view of the same along a plane II defined by dashed and double-dotted lines in FIG. 1 viewed in the direction of the arrow, and FIG. 3 is an enlarged view of a detail Ill indicated by a dashed and double-dotted line in FIG. 2.

As shown in FIG. 1, the cell 100 substantially comprises a prismatic base 2 and two plate-like current collectors 4, 6.

The base 2 accommodates an active part of the storage cell 100 not visible in FIG. 1 and comprises a length L, a width W and a thickness T. It is stipulated that the thickness T is markedly smaller than the width W and the length L. The width W in the specific exemplary embodiment shown is shown as being smaller than the length L. This is not mandatory however; rather the length L and the width W can be substantially equal or the length L can be less than the width W.

The current collector 4 lies over a flat face 2′ of the base 2 and parallel to it, and is fixed by means of fixing means 16a, 16b to the base 2 in a peripheral region, so that it projects from the base 2 in the direction of the length L by an excess length L4 (cf. FIG. 2). An insulating plate 20a is arranged between the current collector 4 and the base 2. In the width direction of the base 2 the current collector 4 has a width W4, which is less than the width W but greater than half the width W. In addition the current collector 4 is arranged eccentrically by a distance E4 in the width direction of the base 2.

The current collector 6 rests on the same flat face of the base 2 as the current collector 4 and is fixed onto the base 2 by means of fixing means 16c, 16d in a peripheral region opposite to the peripheral region on which the current collector 4 rests, so that it projects from the base 2 in the length direction in the opposite sense to the current collector 4 by an excess length L6 (cf. FIG. 2). An insulating plate 20b is arranged between the current collector 6 and the base 2. In the width direction of the base 2 the current collector 6 has a width W6, which is less than the width W but greater than half the width W. In addition the current collector 6 is arranged eccentrically by a distance E6 in the width direction of the base 2. In the exemplary embodiment shown the width B6, the excess length L6 and the eccentricity E6 of the current collector 6 are equal to the width B4, the excess length L4 and the eccentricity E4 of the current collector 4. It is self-explanatory that in variants, different dimensions can be used according to the application and mounting situation.

The current collector 4 comprises a through hole 30 in its freely projecting part, while the current collector 6 comprises a through hole 31 in its freely projecting part. Corresponding pegs can engage with these through holes 30, 31, which prevent slipping of the cell in the direction of length L and the width B, and twisting about an axis in the direction of thickness T, and improve the contacting. The through hole 30 in current collector 4 has a different position in the width direction than the through hole 31 in current collector 6. The through hole 31 has a different diameter to the through hole 30. Due to the asymmetric position and the different diameters of the through holes 30, 31 a coding of the installation direction is possible, to secure against incorrect polarity. In variants, multiple through holes can be provided on each current collector. In further variants the coding of the installation direction can also be effected by different diameters of the through holes. In further variants grooves, notches, chamfers, rounded edges can also be introduced into the current collectors 4, 6, or different width, excess or eccentricity of the current collectors 4, 6.

The structure of the accumulator cell 100 becomes clearer from the longitudinal sectional view in FIG. 2. The longitudinal sectional in FIG. 2 is taken along a plane extending in the direction of thickness T and length L and passing through the fixing means 16a, 16c.

As shown in FIG. 2, the base 2 of the cell 100 is substantially formed by an active block 8, which is enclosed together with other installed parts by a casing film 10.

On opposing sides in the length direction lugs 12a, 12b project out of the active block 8 from the anode side and lugs 14a, 14b, 14c from the cathode side. The lugs 12a, 12b of the anode side are grouped together on the one face and arranged between an insulator plate 22, on which the active block 8 is also arranged, and an inner current collector rail 24a. The lugs 14a, 14b, 14c of the cathode side are grouped together on the other side and arranged between the insulator plate 22 and an inner current collector rail 24b. The active block 8 with lugs 12a, 12b, 14a, 14b, 14c, the current collector rail 24a of the anode side and the current collector rail 24b of the cathode side and the insulator plate 22 are jointly surrounded by the casing film 10. The casing film is welded at a suitable point and evacuated.

The current collector rail 24a of the anode side is fixed to the current collector 4 by means of the fixing means 16a, 16b through the casing film 10. Likewise the current collector rail 24b of the cathode side is fixed to the current collector 6 by means of the fixing means 16c, 16d through the casing film 10. The fixing means 16a, 16b, 16c, 16d in the exemplary embodiment shown are rivets which are composed of a conducting material and guarantee a rigid, loss-proof compression and through-contact.

The insulating plates 20a, 20b, and where appropriate, the insulator plate 22, also ensure that the penetration point of the fixing means 16a, 16b, 16c, 16d is sealed. To avoid a short-circuit between the fixing means 16a, 16b of the anode side and the fixing means 16b, 16c of the cathode side via the casing film 10, insulating sleeves 26a to 26d are provided, which are arranged on the shafts of the fixing means 16a, 16b, 16c, 16d in the area of the insulating plates 20a, 20b, the casing film 10 and the insulator plate 22. In variants of this exemplary embodiment the insulating sleeves 26a to 26d can be dispensed with if the shafts of the fixing means 16a, 16b, 16c, 16d have an insulating surface layer. The insulating sleeves 26a to 26d can be connected to the shafts of the fixing means 16a, 16b, 16c, 16d in a loss-proof manner by shrink-fitting them, where possible in a region of reduced shaft diameter. In further variants the insulator plate 22 can have collar-like elevations around the penetration openings for the fixing means 16a to 16d, which engage in corresponding indentations on the side of the insulating plates 20a, 20b and push the casing film 10 away from the shafts of the fixing means 16a to 16d. The elevations and indentations can also be arranged vice versa.

The active block 8 substantially consists of a laminate of different types of films, and also the casing film 10 consists of multiple layers, as illustrated in more detail in the enlarged view of the anode end in FIG. 3.

Namely, the active block 8 is formed from three cathode layers 36a, 36b, 36c and two anode layers 44a, 44b, which are arranged alternately on top of one another with interposed separator films. Every anode layer 44a, 44b comprises two anode-active films 40, 40 with a current collector film 42 arranged between them, which merges into one of the lugs 12a, 12b of the anode side. Each cathode layer 36a, 36b, 36c comprises two cathode-active films 32, with an interposed current collector film 34, which merges into one of the lugs 14a, 14b, 14c of the cathode side. The cathode-active films 32 in the present exemplary embodiment are composed of a lithium-metal oxide or a lithium-metal compound, the anode-active films 40 of graphite and the separator films of a micro-porous electrolyte. The current collector films 34 of the cathode side in the present exemplary embodiment are composed of aluminium, the current collector films 42 of the anode side of copper. In addition, the first and last layer of an active block is in each case a cathode layer, wherein this first and last layer each have half the capacitance of the intermediate anode and cathode layers. It is self-explanatory that in variants a different number of cathode and anode layers can be chosen, depending on the desired capacitance of the cell.

The casing film 10 comprises three layers, which guarantees an adequate mechanical strength, as well as resistance against electrolyte material and a good electrical and thermal insulation. Thus for example in a manner known per se, the casing film comprises an inner layer 10′ made of a thermoplastic such as polyethylene or polypropylene, a middle layer 10″ made of a metal such as aluminium, and an outer layer 10′″ made of a plastic such as polyamide. The structure of the casing film 10, however, does not form part of the present invention.

In an exemplary production method for producing the active block 8, layers of two cathode-active or anode-active films of equal length are firstly laminated with a fairly long electrode film or current collector film, soaked in a liquid electrolyte and dried. Then the laminated, soaked and dried cathode and anode layers are arranged alternately with separator films interposed such that each of the current collector films of the cathode layers on one side and the current collector films of the anode layers on the other side protrude, and then laminated together. In a variant production method the middle cathode layer can also first of all be laminated in between two separator films, then the two anode layers are laminated onto this core laminate on both sides and in turn laminated in between two separator films, and finally the outer two cathode layers are laminated on. Other sequences are also conceivable.

In FIGS. 4 to 6 a lithium-ion accumulator cell 200 is illustrated as a second concrete exemplary embodiment of an electric energy storage cell according to the invention. Here FIG. 4 is a plan view of the accumulator cell 200, FIG. 5 is a side view of the same in a partial section in a plane V in FIG. 4, and FIG. 6 shows an incomplete state of the cell 200 in a perspective view. Where identical components are used in this embodiment to those in the first embodiment, these are also labelled here with the same or corresponding reference marks. In addition, unless otherwise indicated or it is obviously technically impossible, the designs relating to the first exemplary embodiment are also to be carried over to the present exemplary embodiment.

As shown in FIG. 4, the accumulator cell 200 of this embodiment also has a main body 2 and two current collectors 4, 6 projecting therefrom in opposite directions. The active block 8 contained in the main body 2 is indicated schematically in the Figure with dashed lines.

The structure of the accumulator cell 200 is clearer from a cut-away side view in the central plane V in the right-hand part, than is shown in FIG. 5. The viewing direction here corresponds to an arrow in FIG. 4.

In contrast to the accumulator cell 100 of the first embodiment, the current collector 4 of the cell 200 of this embodiment passes through the casing of the main body 2 into the inside of the same. This is facilitated by the fact that the casing consists of a lower casing film 10a and an upper casing film 10b, which are welded onto a circumferential seam 46, which for example extends up to half the level of the thickness T of the main body. The current collector 4 penetrates this seam 46 in a gas- and liquid-tight manner into the interior of the main body 2. Two lugs 12a, 12b of the anode side, which project out of the active block 8, are connected to the current collector 4. The structure of the active block 8 of the cell 200 of this embodiment corresponds to that in the first exemplary embodiment. However, here the lugs 12a, 12b corresponding to the symmetrical arrangement of the current collector 4 engage in the direction of the thickness T according to their position in the active block 8 from above and below onto the current collector 4, which therefore also serves as a current collector rail of the anode side. In a variant of this concrete exemplary embodiment the lugs 12a, 12b can be first collected together in a current collector rail, which is in turn connected to the current collector 4 inside the casing 10.

The same applies analogously to the current collector 6 and lugs 14a, 14b, 14c of the cathode side.

FIG. 6 is a perspective view of an unfinished assembly state of the cell 200 of the second embodiment of the present invention after an exemplary manufacturing method. It is illustrated how a fully laminated film stack 8 with two lugs 12a, 12b of the anode side which are conductively connected to the current collector 4, and three lugs 14a, 14b, 14c of the cathode side which are conductively connected to the current collector 6, is placed onto the lower casing film 10a which has been cut to size. In the subsequent course of production the upper casing film 10b is applied, the inner space evacuated and the edges of the two casing films 10a, 10b welded together, or suitably connected in a gas- and liquid-tight manner to the current collectors 4, 6. Suitable adhesion and evacuation methods are known per se and are not part of the present invention.

Even if two casing films 10a, 10b are provided in the second embodiment, which are welded at a circumferential seam 46 to film edges placed on top of one another on the inner sides, this arrangement is not mandatory. Instead the active part 8 with the lugs 12a, 12b, 14a to 14c and the inner part of the current collectors 4, 6 can also be worked into a single casing film, which is only welded on three sides. The seam along the longitudinal side of the cell 200 in the present exemplary embodiment is configured such that the inner sides of the film edges overlap one another. This is not mandatory, but an overlapping seam form can also be provided, so that no film edge protrudes anywhere along the longitudinal narrow face of the cell 200.

As shown in FIG. 4, in the second exemplary embodiment also, coding and centring means are provided in the form of through holes 30a to 30d in the collectors 4, 6. More precisely, through holes 30a, 30b are provided in the current collector 4 which are arranged symmetrically in the width direction, and through holes 30c, 30d are provided in the current collector 6 which are arranged asymmetrically in the width direction. It is self-explanatory that arrangements and variants corresponding to the first exemplary embodiment are also conceivable.

In this concrete exemplary embodiment the current collectors 4, 6 extend symmetrically over almost the entire width of the cell 200. It is understood that also with respect to this aspect, arrangements and variants corresponding to the first exemplary embodiment are also conceivable. Likewise the arrangement shown here is also applicable to the first exemplary embodiment.

In the above exemplary embodiments electric energy storage devices of the lithium-ion secondary storage (accumulator) type were described. The invention is applicable however to any type or form of electric energy storage devices. It can be applied to primary storage units (batteries). Similarly the type of the electrochemical reaction for storing and releasing of electric energy is not limited to lithium metal-oxide reactions; rather the individual storage cells can be based on any suitable electrochemical reaction.

### LIST OF REFERENCE MARKS

100, 200 accumulator cell
2 main body
2′ flat face
4 current collector (anode side)
6 current collector (cathode side)
8 active block
10 casing film
10′, 10″, 10′″ layers related to 10
10a, 10b upper, lower casing film
12a, 12b lugs (anode side)
14a, 14b, 14c lugs (cathode side)
16a to 16d rivet (fixing means)
20a, 20b outer insulator plates
22 inner insulator plate
24a, 24b current collector rails
26a to 26d insulating sleeves
30, 30a, 30b, 30b, 30c, 30d, 31 through holes in 4, 6
32 film made of cathode material
34 film made of conductor material (cathode side)
36a, 36b, 36c cathode layers
38 separator film
40 film made of anode material
42 film made of conductor material (anode side)
44a, 44b anode layers
46 seam

It is expressly noted that the above list of reference marks forms part of the description.

1. Electric energy storage cell, having
an active part, which is designed and adapted to store electric energy supplied externally and to release stored electric energy to the exterior;
a casing consisting of a film material, which surrounds the active part in a gas- and liquid-tight manner; and
at least two current collectors that are connected to the active part and are designed and adapted to supply electric current externally to the active part and to release electric current released by the active part to the exterior,
wherein the part that is surrounded by the casing follows the contours of a prismatic structure of substantially ashlar-formed form, said structure extending to a substantially lesser extent in a first spatial direction than in the other two remaining spatial directions, and thus defining two opposing, substantially parallel flat faces and four narrow faces that connect the two flat faces, and
wherein the first and the second current collectors project from the casing parallel to the planes of the two flat faces in opposite directions,
wherein
the extension of said first and second current collector along the narrow faces from which they project is greater than half the length of said narrow faces.

2. The electric energy storage cell according to claim 1,
wherein
extension of the first and the second current collector along the narrow faces from which they project is at least two thirds, preferably at least three quarters of the length of said narrow faces.

3. The electric energy storage cell according to claim 2,
wherein
at least one of the first and the second current collectors is arranged eccentrically with respect to the respective narrow face.

4. The electric energy storage cell according to claim 2,
wherein
at least one of the first and the second current collectors is arranged centrally with respect to the respective narrow face.

5. The electric energy storage cell according to claim 4,
wherein
the first and the second current collector extend substantially over the entire length of the narrow faces from which they project.

6. The electric energy storage cell according to claim 5,
wherein
the casing consists of a preferably laminated film, which surrounds the laminate formed from electrodes and separation layers in a gas- and liquid-tight manner.

7. The electric energy storage cell according to claim 6,
wherein
the casing consists of a first insulating layer, a conductor layer and a second insulating layer, wherein the insulating layers preferably consist of a plastic, and the conductor layer preferably consists of aluminium or an aluminium alloy or another metal or another metal alloy.

8. The electric energy storage cell according to claim 7,
wherein
the casing has at least one weld seam, preferably two weld seams extending along opposing narrow faces, particularly preferably also a weld seam extending beyond one of the two flat faces or along a third narrow face.

9. The electric energy storage cell according to claims 8,
wherein
the casing has two partial films which are welded together along the narrow faces.

10. The electric energy storage cell according to claim 9,
wherein
at least one of the current collectors has an inner part, located inside the casing, and an outer part, located outside the casing, wherein the inner part of the current collector is connected to the active part of the storage cell.

11. The electric energy storage cell according to claim 10,
wherein
the at least one current collector is passed through a weld seam of the casing.

12. The electric energy storage cell according to claim 11,
wherein
at least one of the current collectors rests on the outside of the casing and is contacted to the active part through the casing.

13. The electric energy storage cell according to claim 12,
wherein
at least one of the current collectors in the projecting region has at least one through hole.

14. The electric energy storage cell according to claim 13,
wherein
at least one of the current collectors in the projecting region can also have a plurality of through holes, wherein preferably at least one of the through holes has a different diameter than other through holes.

15. The electric energy storage cell according to claim 14,
wherein
one of the current collectors in the projecting region has at least one through hole at a point in the width direction at which the other current collector has no through hole in the projecting region.

16. The electric energy storage cell according to claim 15,
wherein
the storage and release of the electric energy take place by means of respective electrochemical reactions.

17. The electric energy storage cell according to claim 16,
wherein
said cell is a galvanic cell, in particular a galvanic secondary cell.

18. The electric energy storage cell according to claim 17,
wherein
the active part comprises a plurality of electrodes of two types, wherein in each case an electrode of a first type is separated by a separation layer from the electrode of a second type, wherein the electrodes of the first type and the electrodes of the second type are each connected to each other and to one of the current collectors.

19. The electric energy storage cell according to claim 18,
wherein
each electrode is a laminate comprising at least two layers of a chemically active material and at least one layer of an electrically conducting material and is soaked with an electrolyte material, wherein the layer or the layers of the electrically conducting material has a greater length than the layers of the respective chemically active material and projects from one side of the laminate, wherein the laminates of the electrodes with interposed separation layers are arranged and preferably laminated such that the layers of electrically conducting material of the electrodes of the one type project and are connected together on one side, which lies opposite in the longitudinal direction to a side on which the layers of electrically conducting material of the electrodes of the other type project and are connected together.

20. The electric energy storage cell according to claim 19,
wherein
the chemically active material of at least one of the electrodes comprises a lithium compound.

21. The electric energy storage cell according to claim 20,
wherein
the chemically active material of at least one of the electrodes comprises graphite.

22. The electric energy storage cell according to claim 21,
wherein
the separation layer comprises an electrolyte material.

23. The electric energy storage cell according to claim 22,
wherein
the active part is evacuated.
